(19) United States
(12) Patent Application Publication
(10) Pub. No.: US 2023/0097407 A1
(43) Pub. Date: Mar. 30, 2023

(54) DIGITAL TAG

(71) Applicant: Visa International Service Association, San Francisco, CA (US)

(72) Inventors: Vikram Modi, Lafayette, CA (US); Shantnu Singh, San Francisco, CA (US); Ramji Sethuraman, San Francisco, CA (US); Jarkko Oskari Sevanto, San Francisco, CA (US); Caleb Watson, San Francisco, CA (US); Anshu Chauhan, San Francisco, CA (US); Sonal Verma, San Francisco, CA (US); Micael Gomes, San Francisco, CA (US)

(73) Assignee: Visa International Service Association, San Francisco, CA (US)

(21) Appl. No.: 17/907,932

(22) PCT Filed: Apr. 30, 2021
(86) PCT No.: PCT/US2021/030145

§ 371 Date: Aug. 29, 2022

Related U.S. Application Data
(60) Provisional application No. 63/018,769, filed on May 1, 2020.
(60) Provisional application No. 63/067,969, filed on Aug. 20, 2020.
(60) Provisional application No. 63/152,209, filed on Feb. 22, 2021.

(51) Int. Cl. G06Q 20/32; G06Q 20/40; H04L 67/55

(52) U.S. Cl. CPC G06Q 20/3227; G06Q 20/4014; H04L 67/55

(57) ABSTRACT

A method is disclosed. The method comprising receiving, by a transfer application on a first user's device, a payload comprising a digital tag associated with a second user, a transaction identifier, and a transaction amount. Transmitting, by the transfer application to a digital tag computer, the digital tag associated with the second user. Receiving, by the transfer application from the digital tag computer, a primary account number or token associated with the digital tag and transmitting, by the transfer application to an acquiring computer, a push transfer message.

### CROSS-REFERENCES TO RELATED APPLICATIONS

This application is a PCT application, which claims priority to and the benefit of U.S. Provisional Patent Application No. 63/018,769, filed May 1, 2020, U.S. Provisional Patent Application No. 63/067,969, filed Aug. 20, 2020, and U.S. Provisional Patent Application No. 63/152,209, filed Feb. 22, 2021, all of which are herein incorporated by reference in their entirety.

### BACKGROUND

Many transactions are completed by exchanging a primary account number between a first user and a second user. Often, it is difficult to remember or correctly input the primary account number (e.g., a set of sixteen alphanumeric characters which links to an account) into a transfer application which facilitates transaction. Additionally, there may be privacy concerns with a first user learning the primary account number of a second user.

Many transfer applications allow users of the application to easily transact with other users of the same application. Such an application may use an alias (e.g., an email address, a phone number, etc.) to facilitate a transaction over a primary account number. The use of an alias allows for users to easily direct transactions to users of the same application, however the specific alias used may not be used by all transfer applications. Furthermore, email addresses and phone numbers are increasingly considered sensitive personal data and users may not be comfortable to share those with parties they don't know that well.

Embodiments of the disclosure address this problem and other problems individually and collectively.

### SUMMARY

One embodiment of the invention includes a method. The method comprises: receiving, by a transfer application on a first user device, a payload comprising a digital tag associated with a second user, and a transaction amount; transmitting, by the transfer application to a digital tag computer, the digital tag associated with the second user; receiving, by the transfer application from the digital tag computer, a primary account number or token associated with the digital tag; generating, by the transfer application, a push transfer message comprising the transaction amount, and the primary account number or token associated with the second user; and transmitting, by the transfer application to a transport computer, the push transfer message.

Another embodiment includes a user device comprising: a processor and a computer readable medium comprising instructions which cause the user device to: receive, by a transfer application on a first users device, a payload comprising a digital tag associated with a second user, and a transaction amount; transmit, by the transfer application to a digital tag computer, the digital tag associated with the second user; receive, by the transfer application from the digital tag computer, a primary account number or token associated with the digital tag; generating, by the transfer application, a push transfer message comprising the transaction amount, and the primary account number or token associated with the second user; and transmit, by the transfer application to a transport computer, the push transfer message.

Yet another embodiment includes a method. The method comprises: receiving, by a digital tag computer, a payload comprising a digital tag associated with a second user, and a transaction amount; retrieving, by the digital tag computer from a database associated with the digital tag computer, a primary account number or token associated with the digital tag; and transmitting, by the digital tag computer to a transfer application on a first user device, the primary account number or token indicated by the digital tag associated with the second user.

A better understanding of the nature and advantages of embodiments of the present invention may be gained with reference to the following detailed description and accompanying drawings.

### BRIEF DESCRIPTION OF THE DRAWINGS

FIG. 1A shows an example flow for a user requesting issuance of a digital tag from an authorizing entity.

FIG. 1B shows an example flow for a user requesting issuance of a digital tag from an aggregation entity.

FIG. 2 shows an example flow for a transaction between a first user and a second user associated with an aggregation entity via a transfer application.

FIG. 3 shows an example flow for a transaction reversal.

FIG. 4 shows an example flow for requesting issuance of a digital tag linked to a virtual credential from a transfer application.

FIG. 5 shows an example flow for a transaction between a first user and a second user using a digital tag linked to a virtual credential.

FIG. 6 shows a block diagram of a user device 600 according to embodiments.

FIG. 7 shows a block diagram of a digital tag computer 700 according to embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be any suitable device that a user can interact with (e.g., a payment card or mobile phone). User devices may be in any suitable form. Some examples of user devices include cards (e.g., payment cards such as credit, debit, or prepaid cards) with magnetic stripes or contactless elements (e.g., including contactless chips and antennas), cellular phones, PDAs, personal computers (PCs), tablet computers, and the like. In some embodiments, where a user device is a mobile device, the mobile device may include a display, a memory, a processor, a computer-readable medium, and any other suitable component.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e. using the other device as a modem—both devices taken together may be considered a single mobile device).

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “aggregation entity” may typically be an entity that aggregates something. In some embodiments, an aggregation entity can aggregate merchants engaged in transactions and can sell goods or services, or provide access to goods or services. An aggregation entity may operate a server computer, which may be generically referred to as an “aggregation entity computer”.

A “merchant” may typically be an entity that engages in transactions and can sell goods or services, or provide access to goods or services. In some embodiments, a merchant may be a seller which lists a good and/or service on a website hosted by the aggregation entity.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may be a transfer application.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other information that may be replaced with a substitute value (i.e., token). Tokenization enhances transaction efficiency and security.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Many person-to-person and person-to-merchant payment methods exist. A first user may choose to send a payment to a second user for a good and/or service. The first user may choose one of a plurality of transfer applications (e.g., a digital wallet) to conduct the payment. Additionally, the second user may list the good and/or service on a plurality of aggregation entities such as marketplaces offered by social networks or other websites. The plurality transfer applications and the plurality of aggregation entities need to capable of transacting. Embodiments of the invention streamline transactions by using a digital tag. The digital tag may be shared by the users and can link to a payment credential which may be used to conduct a transaction. The digital tag reduces the number of parties the transfer applications and aggregation entities need to interact with to conduct transactions.

In embodiments of the invention, a user such as a resource provider or an individual may request a digital tag. The digital tag may be requested from an authorizing entity associated with the user (e.g., an issuer that maintains an account for the user), or an aggregation entity associated with the user (e.g., a social network site where users list goods and/or services). The digital tag may be linked to a previously issued credential, such as a payment credential issued by an authorizing entity.

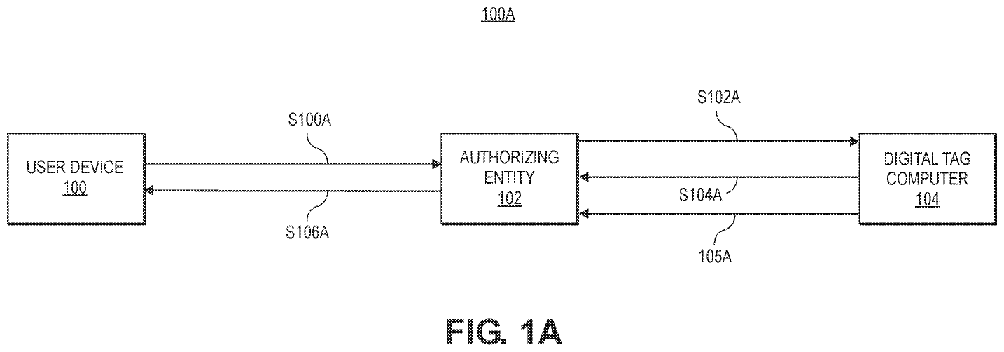

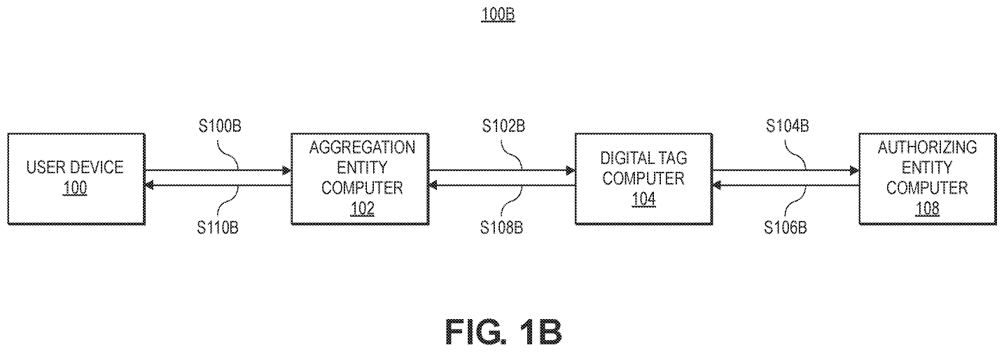

FIG. 1A shows a system comprising a user device 100, an authorizing entity computer 102, and a digital tag computer 104. These devices can be in operative communication with each other.

The components in the system of FIG. 1 and any of the following figures can be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); and Secure Hypertext Transfer Protocol (HTTPS).

FIG. 1A shows an example flow 100A for a user requesting issuance of a digital tag from an authorizing entity 104. The user may be operating a user device 100. In some embodiments, the user device 100 may be a mobile phone. The user may be a resource provider or an individual.

In step S100A, the user device 100 may generate and transmit a request for a digital tag. The request may include a set of alphanumeric characters to be used as the digital tag, and information related to the user operating the user device 100 (e.g., an email address associated with the user, a phone number associated with the user, etc.). The request for a digital tag may then be transmitted to an authorizing entity computer 102 associated with the user. The authorizing entity computer 102 may maintain an account associated with the user which may be indicated by a primary account number.

In step S102A, after receiving the request for a digital tag from the user device 100, the authorizing entity computer 102 may verify the uniqueness of the requested digital tag. The authorizing entity computer 102 can communicate with a database maintained by a digital tag computer 104, which stores previously received requests (e.g., searching a database of digital tags to ensure that the requested digital tag does overlap with plurality of digital tags stored). Although one authorizing entity computer 102 is shown as being in communication with the digital tag computer 104, there may be many authorizing entity computers in communication with the digital tag computer 104.

In step S104A, the authorizing entity computer 102 can receive a message from the digital tag computer 104 verifying the uniqueness of the digital tag. Then, the authorizing entity computer 102 may issue the digital tag by linking the digital tag to the primary account number of the user's account. In some embodiments, the digital tag may be linked to an alternative account identifier such as a payment token.

In step S105A, the issued digital tag and primary account number, or alternative account identifier, may be transmitted to the digital tag computer 104 to be stored in a database. The issued digital tag may be in any suitable format. For example, the issued digital tag may be a payment token, a data string comprising a username and authorizing entity identifier, a phone number, a label (e.g., QR code).

In step S106A, the authorizing entity computer 102 may transmit the issued digital tag to the user device 100.

FIG. 1B shows a system comprising a user device 100, an authorizing entity computer 102, a digital tag computer 104, and an aggregation entity computer 106. These devices can be in operative communication with each other.

FIG. 1B shows an example flow 100B for a user requesting issuance of a digital tag from an aggregation entity. The aggregation entity may be a social network computer system.

In step S100B, the user device 100 may generate a request for a digital tag. The request may include a set of alphanumeric characters to be used as the digital tag, and information related to the user operating the user device 100 (e.g., an email address associated with the user, a phone number associated with the user, etc.). The request for a digital tag may then be transmitted to an aggregation entity computer 106.

In step S102B, the aggregation entity computer 106 may verify the request. For example, the verification may comprise checking the information related to the user included in the request matches some information stored by the aggregation entity computer 106. This may entail the aggregation entity computer 106 requesting a secret (e.g., a password or PIN) from the user of the user device 100, and then verifying that it matches a secret that was previously received by and stored at the aggregation entity computer 106. After verifying the request, the aggregation entity computer 106 may transmit the digital tag request to a digital tag computer 104.

In step S104B, after receiving the digital tag request, the digital tag computer 104 may transmit the request to an authorizing entity computer 102.

In step S106B, the authorizing entity computer 102 may verify that the user was verified in step S102B and generate and issue the digital tag. The digital tag may be issued by linking the digital tag to the primary account number of the user's account. In some embodiments, the digital tag may be linked to an alternative account identifier such as a payment token. The authorizing entity computer 102 may transmit the issued digital tag to the digital tag computer 104. The digital tag may be in any suitable format. For example, the digital tag may be a payment token, a data string comprising a username and authorizing entity identifier, a phone number, a label (e.g., QR code).

In step S108B, after receiving an issued digital tag, the digital tag computer 104 may store the digital tag in a database. The digital tag computer 104 may then transmit the issued digital tag to the aggregation entity computer 106.

In step S110B, the aggregation entity computer 106 may transmit the issued digital tag to the user device 100.

In embodiments of the invention, a user can first download and install, or access in any suitable manner, a transfer application with the ability to send, receive, and request transactions on their user device. The transfer application may be a stand-alone application such as a digital wallet application, a banking application, etc. In some embodiments, the user may add one or more payment cards or instruments to the transfer application.

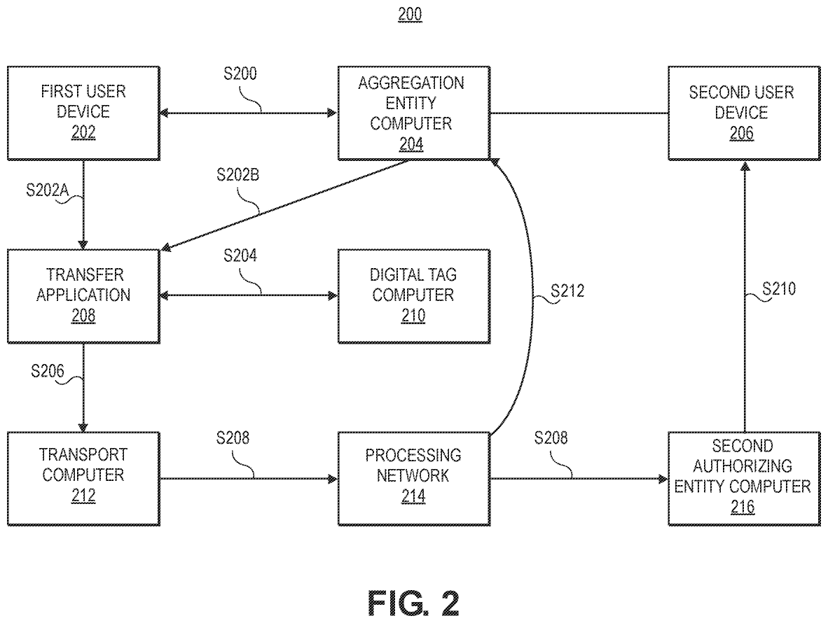

FIG. 2 shows an example flow 200 for a transaction between a first user operating a first user device 202, and a second user operating a second user device 206. The second user operating the second user device 206 may be associated with an aggregation entity operating a aggregation entity computer 204. For example, the second user may be a merchant that sells goods or services in a social network marketplace operated by the aggregation entity computer 204. The first user may use the first user device 202 to purchase goods or services from the second user operating the second user device 206 via the aggregation entity computer 204.

The first user device 202 may include a transfer application 208. The transfer application 208 may be a digital wallet application, a peer to peer payment application, etc. The transfer application 208 may be associated with an application server (not shown) that facilitates the functions of the transfer application 208.

In some embodiments, the aggregation entity operating the aggregation entity computer 204 may be linked directly to the transfer application 208. For example, an aggregation entity computer 204 may host an application service for the transfer application 208 and be able to transmit data directly to the transfer application 208, or the transfer application 208 may be able to access the data hosted by the aggregation entity computer 204.

The transfer application 208 on the first user device 202 can be in communication with a digital tag computer 210. The transfer application computer may also be in operative communication with a second authorizing entity computer 216 associated with the second user of the second user device 206, via a transport computer 212 and a processing network 214. The processing network 214 may also be in communication with the aggregation entity computer 204. The second authorizing entity computer 216 may hold an account associated with the second user of the second user device 206.

A method can now be described with reference to FIG. 2.

In step S200, the first user device 202 may select a good or service provided by a second user and initiate a transaction with the aggregation entity computer 204. In some embodiments, initiating the transaction may comprise the first user operating the first user device 202 selecting a “pay” and/or “checkout” option at the aggregation entity (e.g., on a website hosted by the aggregation entity computer 204). The first user may select to pay using the transfer application 208.

In some embodiments, the first user device 202 may confirm a transaction amount and receive a payload in step S202A. The payload may comprise a transaction amount, a product description, a transaction identifier, and a digital tag associated with the second user. In other embodiments, the first user device 202 may be used to scan a label (e.g., a QR code) which comprises the payload. In other embodiments, the second user of the second user device 206 can share the digital tag verbally, via NFC, Bluetooth, ultrasound, e-mail, etc., with the first user and/or the first user device 202.

In other embodiments, the aggregation entity computer 204 may indicate that it is directly linked with the transfer application 208. The first user device 202 may confirm a transaction amount and initiate a request for a payload to the aggregation entity computer 204 which will be fulfilled in step S202B. In some embodiments, the first user device 202 may be used to scan a label (e.g., a QR code) which comprises the payload. The transfer application 208 may be used to scan the label.

In step S202A, the first user device 202 may route the payload to the transfer application 208 stored on the first user device 202. The transfer application 208 may then store the payload. The transfer application 208 may be in communication with a first authorizing entity (not shown in FIG. 2) which operates a first authorizing entity computer, and maintains an account for the first user.

In step S202B, in an alternative embodiment, after the first user device 202 confirms the transaction amount, the aggregation entity computer 204 may transmit a payload to the transfer application 208. The transfer application 208 may store the payload. The transfer application 208 may be in communication with a first authorizing entity (not shown in FIG. 2) which maintains an account for the first user.

In some embodiments, the transmission of the payload from the aggregation entity computer 204 to the transfer application 208 can occur directly, or via the digital tag computer 210 or the processing network 214, in some embodiments. For example, after the first user device 202 selects a “pay” and/or “checkout” option at the aggregation entity, the first user device 202 may be directed to a digital tag hub operated by the digital tag computer 210 (e.g., via an API or link). The digital tag hub may transmit the payload to the transfer application 208.

In some embodiments, the transfer application 208 itself may maintain an account for the first user. The account may have a pre-loaded balance of funds. The transfer application 208 may determine if the first user has enough funds in the pre-loaded balance to complete the transaction. If the transfer application 208 determines the pre-loaded balance is not sufficient, the transfer application 208 may initiate a pull transaction to add funds to the pre-loaded balance before proceeding with the transaction (e.g., via a debit card account associated with the first user). In some embodiments, only one of step S202A and S202B may occur.

In step S204, after receiving the payload and determining that the first user has sufficient funds for the transaction, the transfer application 208 may transmit the digital tag associated with the second user to a digital tag computer 210. The digital tag computer 210 may resolve the digital tag associated included in the payload to a credential. In some embodiments, the credential may be a payment credential such as a primary account number associated with the second user. For example, the digital tag computer 210 may access a digital tag directory (e.g., a database that stores a mapping between a digital tag and a primary account number) and transmit the retrieved primary account number to the transfer application 208. In some embodiments, the transfer application 208 may transmit the payload to the digital tag computer 210, and the digital tag computer 210 may store the payload in a database.

In step S206, after receiving the primary account number from the digital tag computer 210, the transfer application 208 may transmit a push transfer message to a transport computer 212. In some embodiments, the push transfer message may be an original credit transaction message. The push transfer message may comprise the transaction amount, the transaction identifier, an account identifier or token associated with the first user, and the primary account number associated with the second user.

In some embodiments, the push transfer instruction message may be an OCT (Original Credit Transaction) message. An OCT (Original Credit Transaction) can be a clearing and settlement credit transaction designed for use in business applications such as a business money transfer or business-to-consumer repayments. The OCT can be a transaction used to deliver funds to the recipient account. It is separate from, and can take place after, an AFT transaction in some cases. This timing is to ensure that payment funds are secured before funds are sent to the recipient.

In step S208, after receiving the push transfer message from the transfer application 208, the transport computer 212 may route the push transfer message to a second authorizing entity computer 216 via a processing network 214. The second authorizing entity computer 216 may maintain an account for the second user and add (i.e., credit) the transaction amount to the account of the second user.

In step S210, after depositing the transaction amount into the account associated with the second user, the second authorizing entity computer 216 may transmit a notification message to the second user device 206 notifying them of the transaction completion.

In step S212, any time after routing the push transfer message to the second authorizing entity computer 216, the processing network 214 may transmit a notification message to the aggregation entity computer 204. The notification message may comprise the transaction identifier or the payload and a time stamp. The time stamp may be a time when the transaction was completed. The aggregation entity computer 204 may maintain a database of completed transactions. For example, the database may store the payload associated with the transaction identifier.

At a later time, actual funds may be transferred from the first authorizing entity (or its computer) associated with the first user of the first user device 202, to the second authorizing entity computer 216 of the second authorizing entity, via the processing network 214 in a settlement process.

The above embodiment allows for the digital tag to efficiently route transactions directed to the second user. For example, the second user may choose to list the good and/or service on several websites hosted by a plurality of aggregation entities. The second user may only need to provide the digital tag to the plurality of aggregation entities. In traditional methods, a first user has the option to use a plurality of transfer applications to conduct a transaction with any one of a plurality of aggregation entities. This requires a communication channel for each combination of transfer application and aggregation entity. In addition, some aggregation entities may require users to register with one of the transfer applications that they are compatible with. In embodiments of the invention, the digital tag computer may facilitate these transactions, requiring any single transfer application and the aggregation entity to have a communication between themselves and the digital tag computer. The digital tag is used to route transactions by resolving a digital tag of a second user which displays its digital tag via the aggregation entity into a credential which may be used for the transaction.

In some embodiments, the first user may generate a transaction reversal request. The transaction reversal request may be a request to refund the transaction amount associated with a transaction identifier. For example, the first user may wish to return the good associated with a transaction identifier and receive the transaction amount which was paid for the good.

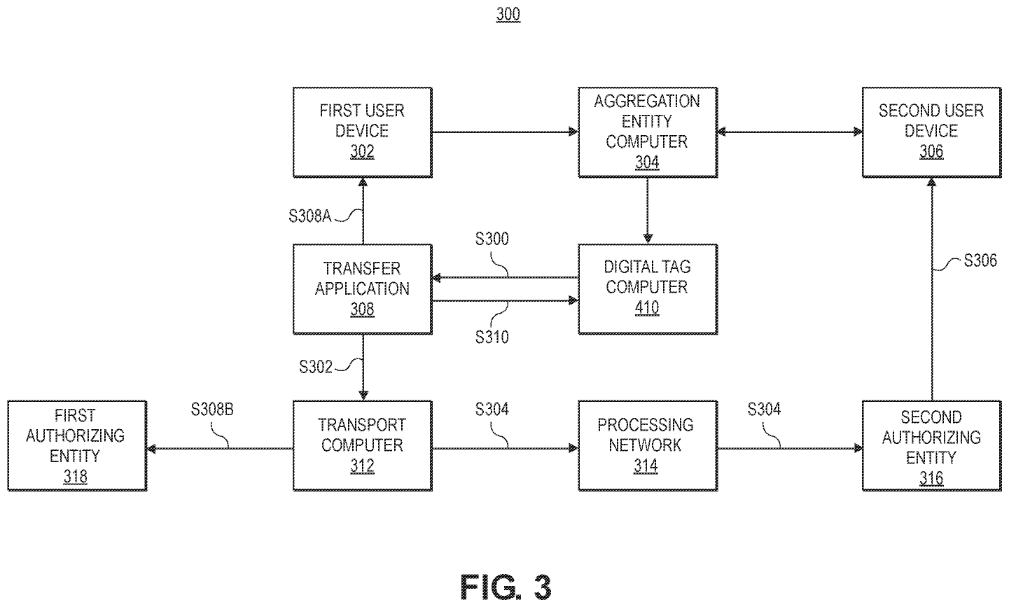

FIG. 3 shows an example flow 300 for a transaction reversal. In a first scenario (the first scenario will include step 308A), the first user operating the first user device 302 may have used funds pulled from an account maintained by a first authorizing entity computer 318 to complete the transaction. In a second scenario (the second scenario will include step 308B), the first user may have used funds from a pre-loaded balance from an account maintained by a transfer application 308. The first user may use a first user device 302 to generate a transaction reversal request comprising a transaction identifier.

In some embodiments, the first user device 302 may transmit a transaction reversal request to an aggregation entity computer 304. The aggregation entity computer 304 may notify the second user device 306 of the received transaction reversal request. In either scenario, the second user device 306 and/or the aggregation entity computer 304 may agree to complete the transaction reversal. For example, the aggregation entity computer 304 may notify the digital tag computer 310 to complete a transaction reversal and transmit a payload (which may be an example of a second payload) with a time stamp that is associated with the transaction identifier in the transaction reversal request to the digital tag computer 310.

In other embodiments, the first user device 302 may transmit a transaction reversal request to the transfer application 308. In the first scenario, the transfer application 308 may refuse the transaction reversal request. In the second scenario, the transfer application 308 may agree to complete the transaction reversal. The transfer application 308 may notify the digital tag computer 310 to complete a transaction reversal. The digital tag computer 310 may choose to retrieve a payload and time stamp from a database or from the aggregation entity computer 304 after receiving this notification.

In yet other embodiments, the first user device 302 may transmit a transaction reversal request to the first authorizing entity computer 318. The first authorizing entity computer 318 may notify the first user device 302 to request the transaction reversal at the transfer application 308.

In step S300, after receiving a payload (which may be an example of a second payload) and a notification to complete a transaction reversal (e.g., from the entities described above), the digital tag computer 310 may verify data included in the payload. For example, the digital tag computer 310 may verify the payload received from the aggregation computer 304 is the same payload the digital tag computer 310 stored in a database. After verifying the payload, the digital tag computer 310 may then forward the transaction reversal request to the transfer application 308.

In step S302, after receiving the transaction reversal request from the digital tag computer 310, the transfer application 308 may initiate a peer-to-peer pull transfer. For example, the transfer application 308 may generate a pull transfer message comprising the transaction amount, the transaction identifier, an account identifier or token associated with the first user, and the primary account number associated with the second user. In some embodiments, the pull transfer message may be an account funding transaction message. The pull transfer message may be routed from a transport computer 312 to the second authorizing entity computer 316 via a processing network 314 in step S304.

In some embodiments, the pull transfer message may be an account funding transaction (AFT) message. An AFT (Account Funding Transaction) is a transaction that can supply funds to another account such as a credit, prepaid, debit, ATM or on-line account. An AFT indicator can be used in both the authorization and clearing and settlement transactions. Neither the authorization nor the clearing transaction carries any financial information about the recipient of a money transfer. In some embodiments, the AFT carries only the account number associated with the payment card of the sender. An AFT can also be accompanied by indicators, which allow the sender's card issuing bank to make appropriate authorization decisions. Indicators include channel information such as Mail Order/Telephone Order or Internet, and merchant type. The following data fields can be used in an AFT and can be supported in messages and clearing and settlement transactions. The data fields can include: Processing Code; Merchant Type; CAVV Result Code; Mail Order/Telephone Order/Electronic Commerce Indicator; Mail/Phone/Electronic Commerce Indicator; Transaction ID (XID); and TransStain/CAVV Data.

After receiving the pull transfer message from the processing network 314, the second authorizing entity computer 316 may debit the transaction amount from an account indicated by the primary account number associated with the second user. The transaction amount may then be sent to the transport computer 312. Upon receiving the transaction amount, the transport computer 312 may notify the transfer application 308.

In step S308A (e.g., the first scenario), after the transport computer 312 notifies the transfer application 308 of receiving the transaction amount, the transfer application 308 may credit an account associated with the first user maintained by the transfer application 308 for the transaction amount.

Alternatively, in step S308B (e.g., the second scenario), after the transport computer 312 notifies the transfer application 308 of receiving the transaction amount, the transfer application 308 may credit an account associated with the first user maintained by a first authorizing entity computer 318.

In step S310, after crediting an account associated with the first user, the transfer application 308 may notify the digital tag computer 310. The digital tag computer 310 may then notify the aggregation entity computer 304.

At a later time, actual funds may be transferred from the second authorizing entity operating the second authorizing entity computer 316 associated with the second user of the second user device 306, to the first authorizing entity computer 318 of the first authorizing entity, via the processing network 314 in a settlement process.

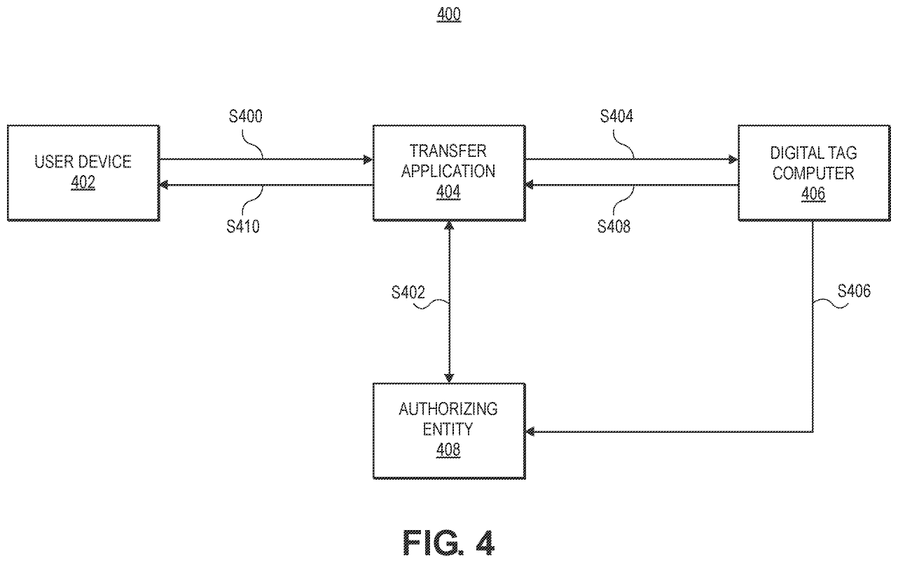

FIG. 4 shows an example flow for requesting issuance of a digital tag linked to a virtual credential from a transfer application 404. The digital tag may be similar to the digital tag of embodiments described above.

In step S400, a user device 402 may request a digital tag from a transfer application 404. The transfer application may be installed on the user device 402. The request may include a set of alphanumeric characters to be used as the digital tag, and information related to the user operating the user device 402 (e.g., an email address associated with the user, a phone number associated with the user, etc.).

In step S402, upon receiving the request for the digital tag, the transfer application 404 may issue a virtual credential via an associated authorizing entity computer 408. The authorizing entity 408 may create and return the virtual credential to the transfer application 404. The virtual credential may be in the form of a real payment credential, but unlike a real payment credential, it cannot be used to independently conduct payment transactions. The credential that will be issued can be a virtual receive only credential (i.e. a credential that only support incoming payments), or the credential can be a fully functional payment credential (e.g. a PAN) that can also be used for purchases, AFTs etc.

In step S404, the transfer application 404 may submit a request to a digital tag computer 406 to create a digital tag associated with the user. The request may comprise the digital tag chosen by the user in step S400, and the virtual credential issued by the authorizing entity 408 in step S402.

In step S406, the digital tag computer 406 may receive the request to create a digital tag. The digital tag computer 406 may retrieve the digital tag and the virtual credential from the request. Upon verifying the uniqueness of the digital tag from a database storing previously received requests (e.g., searching a database of digital tags to ensure that the requested digital tag does overlap with plurality of digital tags stored), the digital tag computer 406 may tokenize the virtual credential. After tokenizing the virtual credential, the digital tag computer 406 may store the digital tag, the tokenized virtual credential, and the virtual credential and approve use of the digital tag.

In some embodiments, the virtual credential can be a receive only credential. This can be used to add a layer of security when the token is used by a payment originator to initiate an OCT message. If the token is compromised by a third-party, the third-party will be unable to pull funds from the underlying account.

In step S408, the digital tag computer 406 may confirm the approval of the digital tag with the transfer application 404.

In step S410, the transfer application 404 may notify the user device 402 the digital tag was approved and is available for use. The virtual credential linked to the digital tag may point to an account managed by the transfer application 404.

The digital tag linked to a virtual credential may be used in a peer-to-peer transaction. For example, a first user using a first transfer application may send, receive, or request a transaction with a second user using a second transfer application. The digital tag allows for the transaction to be initiated with the digital tag of the second user which will then be resolved into a virtual credential that links to an account managed by the transfer applications of the second user.

Note that the virtual credential can be used instead of the real credential as described above in the process of FIGS. 2-3.

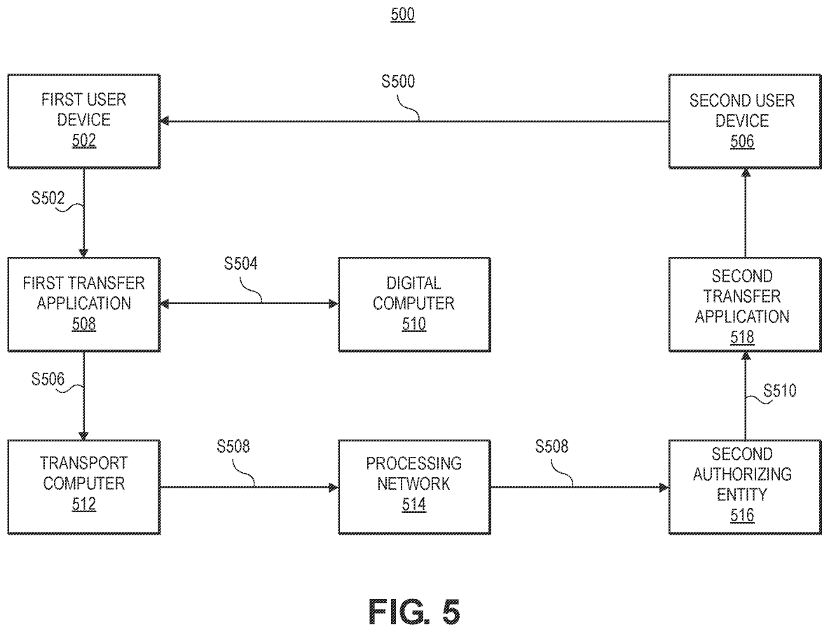

FIG. 5 shows an example flow for a transaction between a first user and a second user using a digital tag linked to a virtual credential. In this embodiment, there is no aggregation computer 502 that is between the first user device and the second user device 506.

In step S500, the second user device 506 may share their digital tag with the first user device 502. In some embodiments, the second user device 506 may display a label (e.g., a QR code) comprising the digital tag for the first user device 502 to scan. In other embodiments, the second user of the second user device 506 can share the digital tag verbally, via NFC, Bluetooth, ultrasound, e-mail, etc.

In step S502, the first user device 502 may route the digital tag to a first transfer application 508 stored on the first user device 502. In some embodiments, the first user device 502 may enter the received digital tag and an amount of funds to be sent to the recipient into a first transfer application 508 in step S502. In other embodiments, in step 500, the digital tag may be received directly by the first transfer application 508.

In step S504, the first transfer application 508 may send the digital tag to a digital tag computer 510 to resolve the digital tag into a credential. The digital tag computer 510 may then retrieve a credential (e.g., the virtual credential or the tokenized virtual credential stored by the digital tag computer 106 in step S406 of FIG. 4) from a database and return the credential to the first transfer application 508.

In step S506, the first transfer application 508, in conjunction with an transport computer 512, may generate a push transfer message. In some embodiments, the push transfer message may be an original credit transaction message using the virtual credential received. The message may comprise the amount of the transaction, an account identifier (or token) associated with the first user device 502, and the credential linked to the second user device 506. The message may be sent to a second authorizing entity computer 516 via a payment network 514.

In step S508, the second transfer application 518 may receive the payment and deposit the funds into the account associated with virtual credential. The second transfer application 518 may notify the second user device 506 of the received payment in S510. The second transfer application 518 may display a notification to the second user on the completion of the transaction.

The above embodiment allows for a first user using a first transfer application to transact with a second user using any other (or the same) transfer application. A first user may be able to more simply send, receive, and request transactions from a second user, as the digital tag is resolved by a digital tag computer into the virtual credential. The transfer applications may have a communication channel with the digital tag computer to retrieve the virtual credential. The virtual credential may then be used to initiate a transaction. The first user and second user are able to share their respective digital tags to any other user without the need to share their real credential as the digital tag (along with the digital tag computer) contain all necessary routing information needed to complete a transaction (e.g., a user's credential is linked to their digital tag which is resolved by the digital tag computer for use in a transaction).

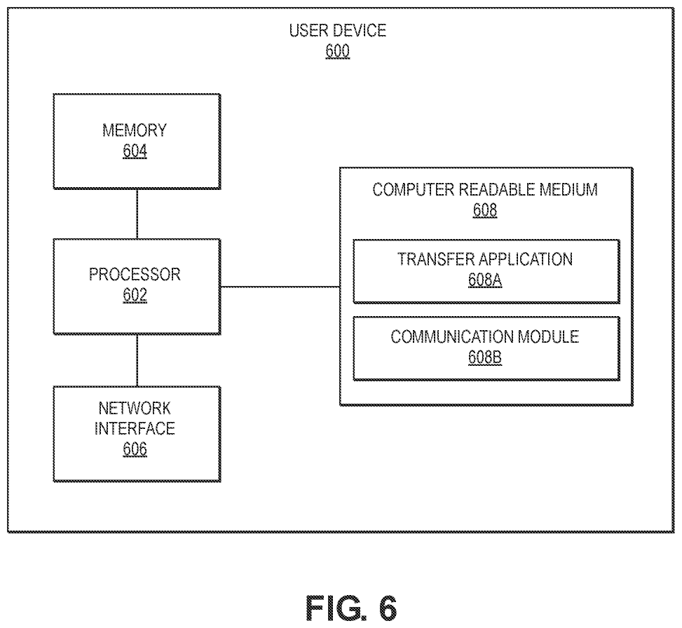

FIG. 6 shows a block diagram of a user device 600 according to embodiments. The user device 600 may be operated by, for example, the first user of FIG. 2. In some embodiments, the user device 600 may facilitate transactions between a user and another party (e.g., the second party listing a good and/or service on the aggregation entity in FIG. 2). The user device 600 may comprise a processor 602. The processor 602 may be coupled to a memory 604, a network interface 606, and a computer readable medium 608. The computer readable medium 608 may comprise any suitable number and types of software modules.

The memory 604 may be used to store data and code. The memory 604 may be coupled to the processor 602 internally or externally (e.g., via cloud based data storage), and may comprise any combination of volatile and/or non-volatile memory such as RAM, DRAM, ROM, flash, or any other suitable memory device. In some embodiments, the memory 604 may store the data items of a payload.

The network interface 606 may include an interface that can allow the user device 600 to communicate with external computers. The network interface 606 may enable the user device 600 to communicate data to and from another device such as an aggregation entity computer, a digital tag computer, a transport computer, an authorizing entity computer, etc. Some examples of the network interface 606 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 606 may include Wi-Fi™. Data transferred via the network interface 606 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 606 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 608 may comprise code, executable by the processor 602, for a method comprising: receiving, by a transfer application on a first users device, a payload comprising a digital tag associated with a second user, a transaction identifier, and a transaction amount; transmitting, by the transfer application to a digital tag computer, the digital tag associated with the second user; receiving, by the transfer application from the digital tag computer, a primary account number or token associated with the digital tag; generating, by the transfer application, a push transfer message comprising the transaction amount, the transaction identifier, an account identifier or token associated with the first user, and the primary account number or token associated with the second user; and transmitting, by the transfer application to a transport computer, the push transfer message.

The computer readable medium 608 may comprise a number of software modules including, but not limited to, a transfer application 608A, and a communication module 608B.

The transfer application 608A may comprise code that causes the processor 602 to receive a payload from an aggregation entity computer. For example, upon receiving a payload from the aggregation entity computer, the transfer application 608A may store the payload in the memory 604. The transfer application 608A may additionally generate push transfer messages and pull transfer messages. In some embodiments, such as the example of FIG. 2, after receiving a payload comprising a transaction amount and resolving the digital tag in the payload to an account identifier or token associated with a second, the transfer application 608A may generate a push transfer message. In some embodiments, such as the example of FIG. 3, after receiving a transaction reversal request, the transfer application 608A may generate a pull transfer message.

The communication module 608B may comprise code that causes the processor 602 to generate messages, forward messages, receive message, reformat messages, and/or otherwise communicate with other entities. In some embodiments, the communication module 608B may facilitate push transfer message and/or a pull transfer message being transmitted to a transport computer.

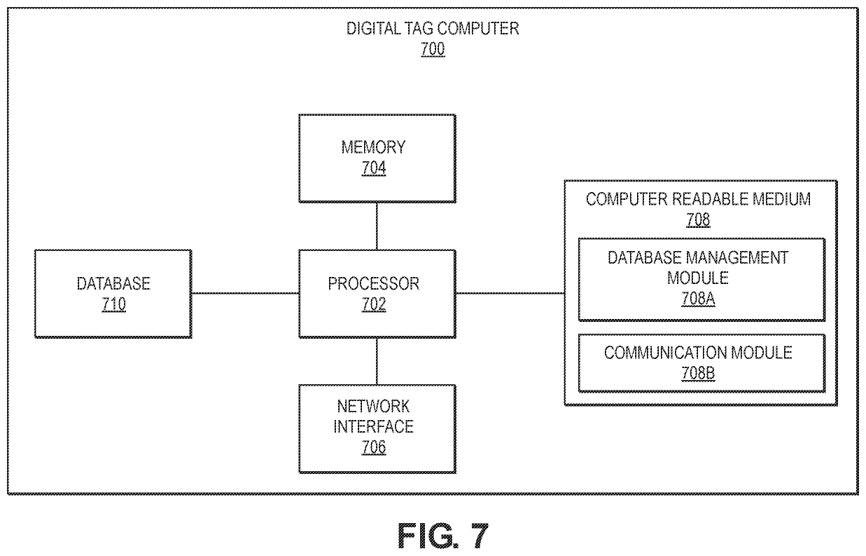

FIG. 7 shows a block diagram of a digital tag computer 700 according to embodiments. The digital tag computer 700 may facilitate the use of a digital tag. For example, the digital tag computer 700 may resolve a digital tag to an account identifier that was linked during the registration of the digital tag. The digital tag computer 700 may store a plurality of digital tags. The digital tag computer 700 may comprise a processor 702. The processor 702 may be coupled to a memory 704, a network interface 706, a computer readable medium 708, and a database 710. The computer readable medium 708 may comprise any suitable number and types of software modules.

The memory 704 can be used to store data and code. In some embodiments, the memory 704 may be linked to a database 710. The memory 704 and/or the database 710 may be coupled to the processor 702 internally or externally (e.g., via cloud based data storage), and may comprise any combination of volatile and/or non-volatile memory such as RAM, DRAM, ROM, flash, or any other suitable memory device. The database 710 may comprise a directory for the link between a digital tag and an account identifier. In some embodiments, the digital tag computer 700 may store the data items (e.g., a digital tag, the account identifier and/or token, etc.) received as a result of issuing a digital tag in the database 710.

The network interface 706 may include an interface that can allow the digital tag computer 700 to communicate with external computers. The network interface 706 may have the same features or different features as the previously described network interface 606.

The computer readable medium 708 may comprise code, executable by the processor 602, for a method comprising: receiving, by a digital tag computer, a payload comprising a digital tag associated with a second user, a transaction identifier, and a transaction amount; retrieving, by the digital tag computer from a database associated with the digital tag computer, a primary account number or token associated with the digital tag; and transmitting, by the digital tag computer to a transfer application on a first user device, the primary account number indicated by the digital tag associated with the second user.

The computer readable medium 708 may comprise a number of software modules including, but not limited to, a database management module 708A, and a communication module 708B.

The database management module 708A may comprise code that causes the processor 702 to manage data stored by the memory 702 and/or the database 710. For example, during issuance of a digital tag (e.g., the process of FIG. 1A, FIG. 1B, and FIG. 4) the database management module 708A may allow the processor 702 to verify the uniqueness of a received digital tag to a plurality of digital tags stored in the database 710. In some embodiments, after the digital tag computer 700 receives a payload, the database management module 708A may retrieve the account identifier or token linked to an issued digital tag included in the payload.

The communication module 708B may comprise code that causes the processor 702 to generate messages, forward messages, receive message, reformat messages, and/or otherwise communicate with other entities. For example, the communication module 708B may allow the processor 702 to receive a request to check the uniqueness of a digital tag from an authorizing entity computer or a user device and generate a response.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a transfer application on a first user device, a payload comprising a digital tag associated with a second user, and a transaction amount;
transmitting, by the transfer application to a digital tag computer, the digital tag associated with the second user;
receiving, by the transfer application from the digital tag computer, a primary account number or token associated with the digital tag;
generating, by the transfer application, a push transfer message comprising the transaction amount, and the primary account number or token associated with the second user; and
transmitting, by the transfer application to a transport computer, the push transfer message.

2. The method of claim 1, wherein the payload received by the transfer application from an aggregation entity computer.

3. The method of claim 1, wherein the payload further comprises a transaction identifier, and the push transfer message further comprises the transaction identifier and the account identifier or token associated with the first user.

4. The method of claim 1, wherein the primary account number or token received is a virtual primary account number or virtual token.

5. The method of claim 1, wherein the push transfer message is an original credit transaction message.

6. The method of claim 1, further comprising:
receiving, by the transfer application, a second payload comprising the digital tag associated with the second user, a transaction identifier, the transaction amount, and a time stamp;
generate, by the transfer application, a pull transfer comprising the transaction amount, the transaction identifier, an account identifier or token associated with the first user, and the primary account number or token associated with the second user; and
transmitting, by the transfer application to the transport computer, the pull transfer message.

7. The method of claim 6, wherein the second payload is received from the digital tag computer.

8. The method of claim 6, wherein the transfer application adds the transaction amount to an account associated with the first user.

9. The method of claim 6, further comprising:
transmitting, by the transfer application to a first authorizing entity computer associated with a first authorizing entity, the transaction amount to be added to an account associated with the first user managed by the first authorizing entity.

10. The method of claim 6, wherein the pull transfer message is an account funding transaction message.

11. The method of claim 6, wherein the first user device is a mobile device.

12. The method of claim 1, wherein the first user device receives the digital tag associated with the second user from a second user device.

13. A user device comprising:
a processor and
a computer readable medium comprising instructions which cause the user device to:
receive, by a transfer application on a first users device, a payload comprising a digital tag associated with a second user, and a transaction amount;
transmit, by the transfer application to a digital tag computer, the digital tag associated with the second user;
receive, by the transfer application from the digital tag computer, a primary account number or token associated with the digital tag;
generating, by the transfer application, a push transfer message comprising the transaction amount, and the primary account number or token associated with the second user; and
transmit, by the transfer application to a transport computer, the push transfer message.

14. The user device of claim 13, wherein the user device is a mobile phone.

15. The user device of claim 13, wherein the push transfer message is an original credit transaction message.

16. The user device of claim 13, wherein the payload is a first payload, and wherein the computer readable medium further comprises instructions causing the user device to:
receive, by the transfer application, a second payload comprising the digital tag associated with the second user, a transaction identifier, the transaction amount, and a time stamp;
generate, by the transfer application, a pull transfer message comprising the transaction amount, the transaction identifier, an account identifier or token associated with the first user, and the primary account number or token associated with the second user; and
transmit, by the transfer application to an acquiring entity computer, a pull transfer message.

17. The user device of claim 16, wherein the pull transfer message is an account funding transaction message.

18. A method comprising:
receiving, by a digital tag computer, a payload comprising a digital tag associated with a second user, and a transaction amount;
retrieving, by the digital tag computer from a database associated with the digital tag computer, a primary account number or token indicated by the digital tag associated with the second user; and
transmitting, by the digital tag computer to a transfer application on a first user device, the primary account number or token associated with the digital tag associated with the second user.

19. The method of claim 18, further comprising:
receiving, by the digital tag computer, a transaction reversal request comprising a second payload which comprises the digital tag associated with the second user, a transaction identifier, the transaction amount, and a time stamp;
verifying, by the digital tag computer, the second payload; and
transmitting, by the digital tag computer to the transfer application on the first user device, a pull transfer message.

20. The method of claim 18, wherein the primary account number or token retrieved from the database is a virtual primary account number or virtual token.
